(19) United States
(12) Patent Application Publication
(10) Pub. No.: US 2013/0007253 A1
(43) Pub. Date: Jan. 3, 2013

(54) METHOD, SYSTEM AND CORRESPONDING DEVICE FOR LOAD BALANCING

(76) Inventors: Guohuai Li, Qingdao (CN); Xuefeng Yao, Qingdao (CN)

(21) Appl. No.: 13/635,352

(22) PCT Filed: Jul. 6, 2010
(86) PCT No.: PCT/CN2010/073699

§ 371 Date: Sep. 14, 2012

(30) Foreign Application Priority Data
Mar. 30, 2010 (CN) 201010137025.8

(51) Int. Cl. G06F 15/173

(52) U.S. Cl. 709/223

(57) ABSTRACT

The embodiments of the present invention disclose a method, system and corresponding device for load balancing. The present invention involves in a computer application, and solves the technical problems due to the introduction of more mechanism in the prior art. The method of the present invention mainly includes acquiring by a peer address information of at least one SN from a BSSN, both said BSSN and SN belong to an overlay network; if the peer is a server, saving by the server the address information and reporting by the server server information to a SN corresponding to one of the address information, and spreading by the SN the server information to other SNs; if the peer is a client, saving by the client the address information and acquiring by the client the server information from a SN corresponding to the one of the address information and saving the server information.

### RELATED APPLICATIONS

The application claims priority to Chinese Patent Application No. 201010137025.8, titled as “Method, System and Corresponding Device for Load Balancing” filed on Mar. 30, 2010, which is herein incorporated in its entirety by reference.

### FIELD OF THE INVENTION

The invention relates to computer applications, especially to the method, system and corresponding device for realizing load balancing based on an overlay network.

### BACKGROUND

LVS (Linux Virtual Server) is currently one of the commonly used load balancing technologies. As shown in FIG. 1, in the LVS application, the client, such as the user or the graphic monitor of FIG. 1, sends IP packets to a load balancer over the Internet or Intranet. The Linux core of the load balancer is equipped with a load balancing algorithm, through which the load balancer transfers the IP packet to a real server. The application procedure running in the real server respectively processes the corresponding information in the IP packets and directly returns the processed IP packets to the client. Therefore, a capacity expansion can be realized by increasing the number of the real servers and configuring the load balancer accordingly if necessary.

LVS is well-suited for the Internet by providing the load balancing services for the web services. A web service is an application with unsymmetrical upstream and downstream data traffic (i.e., low upstream data traffic and high downstream data traffic). Since the upstream data must pass through the load balancer, there are a large number of IP packets passing through the load balancer if the upstream data is high, in which case, the load balancer's network bandwidth becomes the system bottleneck. The number of real servers that can be driven by one load balancer is limited because all the upstream data must pass through the load balancer, and the system performance and network bandwidth of one load balancer are limited. Hence, the expansion cannot be realized simply by increasing the number of real servers when the number of real servers reaches a threshold.

According to the prior art, some other mechanism have been introduced to ensure the service capacity of the load balancer so as to solve the aforesaid problems. For example, in the LVS, the load balancer becomes a single point because all the upstream and downstream data pass through the load balancer. Therefore, an additional device (e.g., the backup device in FIG. 1) is provided to render the dual hot standby function for the load balancer, and an application such as heartbeat or keep-alive (both heartbeat and keep-alive are names of the open-source software applications that can realize the dual hot standby function) is required for the realization of the dual hot standby.

With regard to the above solutions, the inventors have identified the following problems: the mechanism introduced in the realization of dual hot standby is complicated; and if there is any real server malfunction, a mechanism is required to transfer the heartbeat information between the load balancer and the real server to notify the load balancer so that it will not transmit the IP packets to the malfunctioning real server, which therefore increases the burden of the load balancer.

### SUMMARY

The embodiments of the present invention provide a method, system and corresponding device for load balancing, wherein the system is capable of a higher availability and a smooth expansion capacity.

The embodiments of the present invention provide the following technical solutions to achieve the above targets.

According to one aspect of the invention, a method of load balancing is provided, the method including: acquiring by a peer address information of at least one super node (SN) from a bootstrap super node (BSSN), wherein both said bootstrap super node and said at least one super node belong to an overlay network; if the peer is a server, saving by the server said address information and reporting by the server server information to a respective SN corresponding to one of the address information, and spreading by the SN the server information to other SNs; if the peer is a client, saving by the client said address information and acquiring by the client the server information from a respective SN corresponding to one of the address information and saving the server information at the client.

According to another aspect of the invention, a peer device is provided, the device including: a node acquisition unit for acquiring address information of at least one SN from a bootstrap super node, wherein both the bootstrap super node and the at least one SN belong to an overlay network; a storage unit for storing the address information; an interaction unit for reporting server information to a respective SN corresponding to one of the address information; and/or acquiring the server information from the SN corresponding to the one of the address information; and/or the storage unit is further used for storing the server information.

According to another aspect of the present invention, a node device is provided, wherein the node device belongs to an overlay network, the device including: a bootstrap super unit for receiving a request of acquiring at least one SN from a peer, and sending address information of a SN capable of serving the peer back to the peer, wherein the peer includes a server and a client; a spread unit for receiving and storing server information from the server, and spreading the server information to other node devices; and a supply unit for receiving a request for server information from the client and sending the stored server information to the client.

According to a further aspect of the present invention, a system of load balancing is provided, the system including: a server for acquiring address information of at least one node device from a node device, saving the address information, and reporting its server information to a respective node device corresponding to one of the address information; a client for acquiring address information of at least one node device from a node device, saving the address information, acquiring the server information from the node device corresponding to one of the address information, and saving the acquired server information; at least one node device for receiving a request of acquiring at least one node device from the server and the client, and sending address information of a node device capable of serving the server and the client to said server or client; receiving and saving server information from the server, spreading the server information to other node devices; and receiving a request for the server information from the client and returning the saved server information to the client; wherein, the at least one node device belongs to an overlay network.

In embodiments of the invention, an overlay network is used, and at least one SN in the overlay network is used as an agent, which is used by the client to acquire server information so as to know which server is available. Accordingly, the server can report its server information to one SN, and the one SN spreads the server information to other SNs. By doing so, different SNs in the overlay network can have the same function. Therefore, no single point is formed, and the impact on the entire system during the capacity expansion is small and thus a smooth expansion is realized. Furthermore, no additional complicated mechanism is needed to reduce the load of a single point or secure the service performance of the single point. As such, the complexity of the system is reduced and thus the system is used with a greater facility and is of a high availability.

### BRIEF DESCRIPTION OF DRAWINGS

To illustrate the technical solutions of invention or prior art clearly, description to the accompanying drawings used in the embodiments of the invention or the prior art is made. Obviously, the described drawings are only some embodiments of the invention. Other drawings can be obtained by a skilled in the art based on these drawings without creative efforts.

FIG. 1 is a schematic diagram for the application of LVS in the prior art;

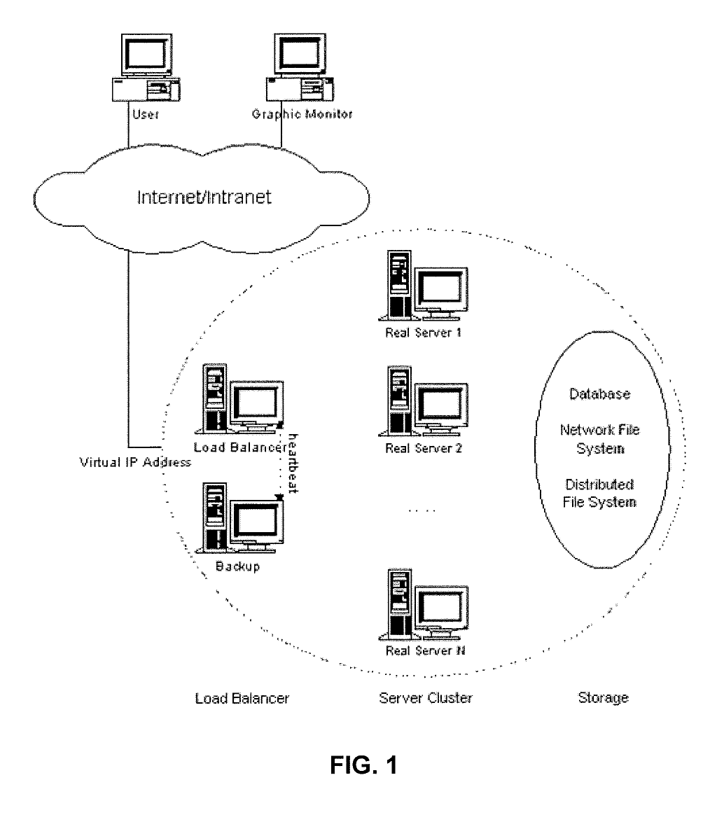

FIG. 2 is a schematic flow diagram of the method of load balancing when the server is used as a peer according to embodiment 1 of the present invention;

FIG. 3 is a schematic flow diagram of updating the address information periodically according to embodiment 1 of the present invention;

FIG. 4 is a schematic flow diagram of the method of load balancing when the client is used as a peer according to embodiment 1 of the present invention;

FIG. 5 is a schematic structure of the peer device according to the second embodiment of the present invention;

FIG. 6 is a schematic structure of the node device according to the third embodiment of the present invention;

FIG. 7 is a schematic structure of the system of load balancing according to the fourth embodiment of the present invention.

### DETAILED DESCRIPTION

A concise and complete illustration to the technical solutions of invention will be made in connection with the accompanying drawings of the invention. Obviously, the described embodiments are only some embodiments of the invention rather than all embodiments of the invention. All other embodiments obtained based on the embodiments of the invention, without creative efforts, fall within the scope of the present invention. Further, the following embodiments are optional solutions for the invention, and the order sequence and the number of the embodiments are independent from the preferred performing orders.

### Embodiment 1

This embodiment provides a method of load balancing, which involves a peer and an overlay network. In this and the following embodiments, the peer, with respect to the overlay network, is an entity that needs to access the overlay network, including a client and a server. The overlay network is formed by nodes that are same. Further, in the overlay network, the node accessed firstly by the peer is considered as a bootstrap super node, and the nodes in the overlay network participating in the method of this embodiment are considered as SNs (a SN may either be a bootstrap super node or not at the same time).

Before executing the method of this embodiment, configurations are made as follows. Service type grouping protocols are specified for the client and server to follow. The protocols specify the IDs of groups, wherein the group ID is the ID of a group to which the SNs in the overlay network belong, and the protocols specify the mapping between group ID and service type; or, the protocol specify the group IDs based on the domain of the service, and the protocols specify the mapping between group ID and service type. Accordingly, a server following said protocols may be informed which SNs may be used according to the service types it can provide. Similarly, a client may be informed which SNs may be used according to the service types to be requested by said client. Accordingly, it is necessary to group the SNs in the overlay network, and assign a group ID for every group in the overlay network.

In addition, after the above configuration, every SN in the overlay network may spread its node information in the entire network by a gossip algorithm. Therefore, the node information related to other SNs is saved in every SN. The node information is updated timely through interactions occurring between SNs to ensure that each SN saves the updated node information related to other SNs. The node information may include the group ID, load status, IP address and etc. of the SN. Because the gossip algorithm has already been applied in the prior art, the specific details of the algorithm are omitted for clarity.

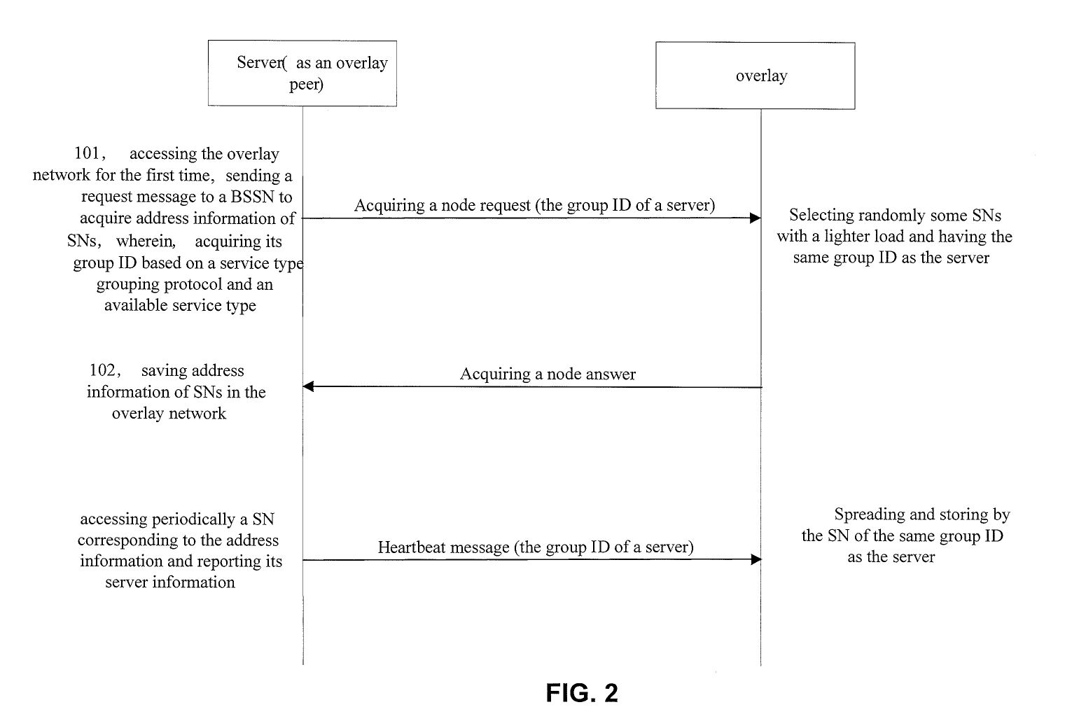

The followings are the specific performing procedures of the method provided by this embodiment in case the server is the peer, as shown in FIG. 2.

At step 101, the peer obtains from the bootstrap super node the address information of at least one SN.

Specifically, the peer is a server. The method of acquiring by the server the address of the bootstrap super node includes (but not limited to) that the operator designates the address of the bootstrap super node via the server, or the bootstrap super node notify the server of its own address by a message, or other methods.

Specifically, the step 101 can be realized as follows. The server obtains the group ID according to provisions of the service type grouping protocol and the available service type, or according to the domain to which said server belongs, and then sends a node requesting message carrying said obtained group ID to said BSSN. Said BSSN sends a node response message to the server according to the group ID sent by the server, wherein the node response message carries the address information of the SN in the overlay network having the same group ID as the group ID sent by the server.

For example, assuming that there are 30 SNs (node1, node2, node3, . . . , node30) in the overlay network, the SNs is grouped during the configuration, for example, 10 groups are divided, with the group ID from 1 to 10.
Node1, node2 and node3 are divided into group 1;
Node4, node5 and node6 are divided into group 2;
Node28, node29 and node30 are divided into group 10;

Provided that there are 4 servers, i.e., Server11, Server12, Server23 and Server24, and the corresponding service types provided by said servers are type11, type12, type23 and type24, respectively. In the service type grouping protocols followed by said servers, the ID of the group in which the SN in the overlay network is available to the service type is as follows:
Type11—group ID 1;
Type12—group ID 1;
Type23—group ID 2;
Type24—group ID 2;

The server may obtain its own group ID according to the service types it can provide and one or more rules of the service type grouping protocol. That is,
Server11 may use the SN with group ID 1;
Server12 may use the SN with group ID 1;
Server23 may use the SN with group ID 2;
Server24 may use the SN with group ID 2;

When the server (here, Server11 or Server12) accesses the overlay network as a peer, it may communicate with SNs (here, node 1, node 2 and node 3), because the server and the SNs have the same Group IDs.

Therefore, taking Server11 as an example, Server11 may obtain the group ID (1) according to the service type (type11) it can provide and one or more rules of service type grouping protocol (type 11—group ID 1), and sends a node requesting message carrying the obtained group ID 1 to said bootstrap super node.

Based on the group ID 1 sent by Server11, the bootstrap super node sends a node response message carrying the address information of the SNs (node1, node2, node3) with the identical group ID in the overlay network back to Served 1.

Alternatively, based on the group ID 1 sent by Server 11, the bootstrap super node selects a SN of a lighter load from the SNs (node1, node2, node3) of the same group ID in the overlay network, sends a node response message carrying the address information of the selected SN of a lighter load to the Served 1. The bootstrap super node may learn the load status of node1, node2 and node3 according to the node information related to other SNs saved by itself

At step 102, the server stores said address information and reports its server information to the SN corresponding to one of the address information. Further, The SN receiving said address information spreads the server information to other SNs.

The step may 102 can be realized as follows. The server periodically sends its server information to an SN corresponding to one of the address information by a heartbeat message carrying the group ID. Because the received the address information may be related to multiple SNs, the address information of one SN can be selected from all address information in a random or polling way.

The SN receiving the server information spreads the received server information to other SNs of the identical group ID in the overlay network.

Accordingly, other SNs of the identical group ID receiving the server information save the received server information. The above server information includes the service types that a server can provide, an IP address and a port number of the server. Optionally, the server information further includes a load status of the server.

For example, Server11 randomly sends the server information by a heartbeat message carrying the group ID 1 to node 1 in the first period.

After receiving the heartbeat message, node 1 spreads the received server information to node 2 and node 3. Accordingly, the node 2 and node 3 will save the received server information of Server11. Server11 randomly selects one SN (for example, Node 1), and sends the server information by a heartbeat message carrying group ID 1 to the selected node 1 in the second period, and so on.

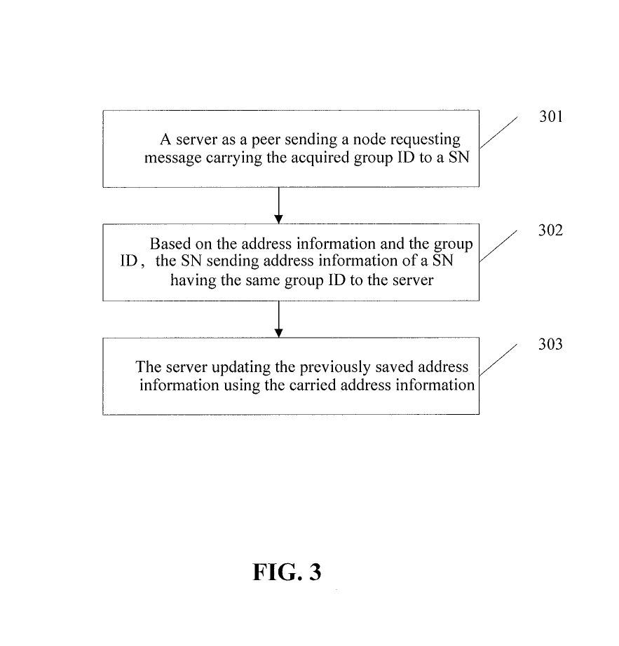

In addition, in this embodiment, after step 101, i.e., after the address information of available SNs has been obtained from the bootstrap super node, steps of FIG. 3 may further be performed.

At step 301, the server as a peer may periodically send a node requesting message carrying the obtained group ID to the SN corresponding to one of the address information.

For example, the server obtains the address information for three SNs A, B and C from the bootstrap super node. The server sends a node requesting message carrying the group ID 1 to node A.

Of course, said SN can be selected from all SNs in a random or polling way. Alternatively, if at step 101, the bootstrap super node sends the address information together with the relevant load status of the corresponding SNs, then address information of the SN with a lighter load can be selected.

At step 302, according to the address information and group ID contained in the node information, the SN receiving the node requesting message from the server sends a node response message carrying address information of the SNs with the identical group ID to the server.

For example, after receiving the node requesting message, the node A finds out that nodes A, B and D are the current SNs of the group ID 1 based on the group ID 1 and the node information of other SNs saved in the node A. The node A sends the node response message carrying the address information of nodes A, B and D to the server.

Accordingly, at step 303, the server updates the saved address information with the carried address information.

For example, the server receives the response information, and updates the original address information of nodes A, B and C by the address information of nodes A, B and D.

By using the above solution, the address information of the SNs on the server can be updated more effectively, wherein said SNs are capable of interacting with the server. Therefore, it is able to avoid that a SN is unavailable or utilized inadequately due to malfunction, removing or adding of the SN, and keep the address information saved on the server valid all the time.

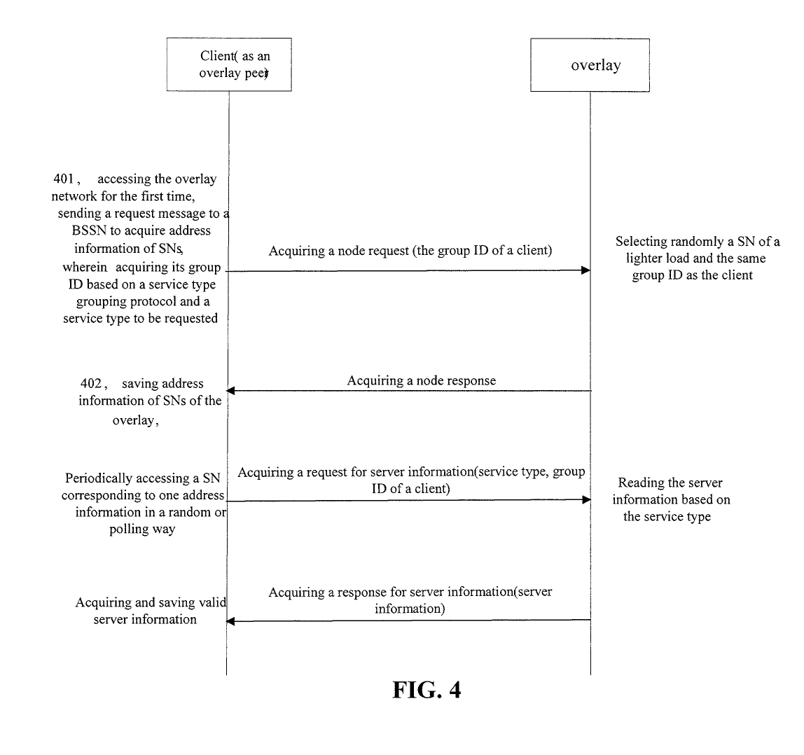

The followings are the specific performed procedures of the method provided by the embodiment with the client as the peer, as shown in FIG. 4.

At step 401, the peer obtains the address information of at least one SN from the bootstrap super node.

Specifically, the peer is a client. The method of acquiring by the client the address of the BSSN includes (but not limited to) that the operator designates the address of the BSSN via the server, or the BSSN notifies the client of its own address by a message, or other methods.

Specifically, step 401 may be realized as follows. The client obtains the group ID according to one or more rules of service type grouping protocol and the service types to be requested, or according to the domain, and sends a node requesting message carrying the obtained group ID to the BSSN. Based on the group ID sent by the client, the BSSN sends a node response message carrying the address information of the SNs with the identical group ID in the overlay network, so as to enable the client to obtain the server information from the SNs of the identical group ID in the overlay network by using the address information, as described at step 402.

If the client, as a peer, needs to obtain several service types, the peer will obtain several corresponding group IDs. So does the server as a peer.

The example for step 401 may refer to that for step 101, except that the server in the step 101 is replaced by the client.

At step 402, the client stores the address information and obtains the server information from a SN corresponding to one of the address information and saves the server information.

Specifically, step 402 may be realized as follows.

The client periodically sends a requesting message for acquiring the server information to the SN corresponding to one of the address information, wherein said requesting message contains the service type to be requested by the client and the group ID. Because the received address information may be related to multiple SNs, the address information of one SN can be selected from all address information in a random or polling way.

The SN receiving said requesting message obtains the server information according to the requested service type, and sends the obtained service information to the client by a response message for acquiring server information.

Because the service type is contained in the server information, the SN can find the server information containing said service type based on the received service type.

For example, the user 11 sends a requesting message for acquiring the server information to the address of node1 in the first period, wherein said requesting message contains the requested service type type11 and the group ID 1 to which user11 belongs. Node1 finds the server information containing type11 according to type11, and sends the server information to user11 by a response message for acquiring server information. The user11 sends a requesting message for acquiring the server information to the address of node2 in the second period, wherein said requesting message carries the requested service type type12 and the group ID to which user11 belongs, and so on.

In the above example, the carried group ID 1 can be used to check if the group ID 1 of user11 is identical to the group ID of node 1 before node 1 sends the server information to user11. If not, the server information is not sent to user11, and thus the security of information is enhanced.

In addition, in this embodiment, after step 401, i.e., after acquiring the address information for available SNs from the BSSN, the client may further periodically update the address information stored on it by accessing the SN corresponding to one of the address information. The performing details are similar to those for the server as shown in FIG. 3, and thus are omitted herein.

If the client requires multiple service types to be provided, it accesses multiple service types. Hence, the client needs to access the overlay network successively by multiple group IDs, to obtain and store the corresponding server information, the performing details are as above and thus omitted herein.

After the client stores the server information, the methods of this embodiment may further include:

When the client requests service from the server, the client sends the request to the server capable of providing the service based on the server information saved on said client in a random or polling way, or sends the request to the server of a lighter load as indicated by the server information. Here, the server capable of providing the service refers to a server that is capable of providing the service type as requested by the client.

For example, user11 requests the service type type11. According to the server information saved on user11, it can be seen that Server11 and server12 are both able to provide the service type. Further, because Server 11 is of a lighter load, or user11 selects Server11 randomly, user11 sends to Server 11 the service request for type11.

Furthermore, in this embodiment, as the client obtains server information through the SNs in the overlay network, and the SNs are of same functions, an expansion of a certain service can be achieved by adding corresponding server directly if the expansion is necessary, and an expansion of the overlay can be achieved by adding corresponding nodes directly if the expansion of the overlay is necessary. No modification to other elements of the network is required. The server may inform SNs in the overlay network by a heartbeat message, therefore, the SN is aware of the adding or removing of the server, and the SN can notify other SNs in the overlay network by a gossip algorithm. The client also accesses the SN of the overlay network periodically to obtain the needed server information of a server. Therefore, if a new server is added or removed, the client may also update the address information and server information saved by it based on the results by periodical accesses.

It is noted that, when performing the above method for this embodiment, configurations of grouping SNs and following by the peer the service type grouping protocol are required. In the other embodiment of the present invention, the method of load balancing can be realized without requiring configurations of grouping and following by the peer the protocol, and the main differences are as follows: the peer (including the server and client) interacts with SNs of the overlay network without carrying the group ID. Accordingly, when the SN spreads the server information, the server information may be spread to the entire overlay network by a gossip algorithm without the group ID. When the SN saves the server information, it saves the server information of all servers. This method can also enhance the availability and realize a smooth expansion. However, in case there is a large amount of the server information or there are lots of the SNs in the overlay network, if the server information is spread over the entire network, it results in wasting the network resources such as the network bandwidth and other resources. Therefore, this method is suitable when the overlay network is not massive and the server information to be processed is not huge.

According to the method of this embodiment, the client dynamically obtains available server information from the SN and the server dynamically reports to the SN the valid sever information; moreover, the entire implementation solution is not limited on a fixed SN, thus no single point is formed, the upstream and downstream data volume is not limited, and the availability and fault-tolerant capability are improved. Furthermore, because the expansion does not affect other network elements such as the client, SN of the overlay network and etc., a smooth extension can be realized.

### Embodiment 2

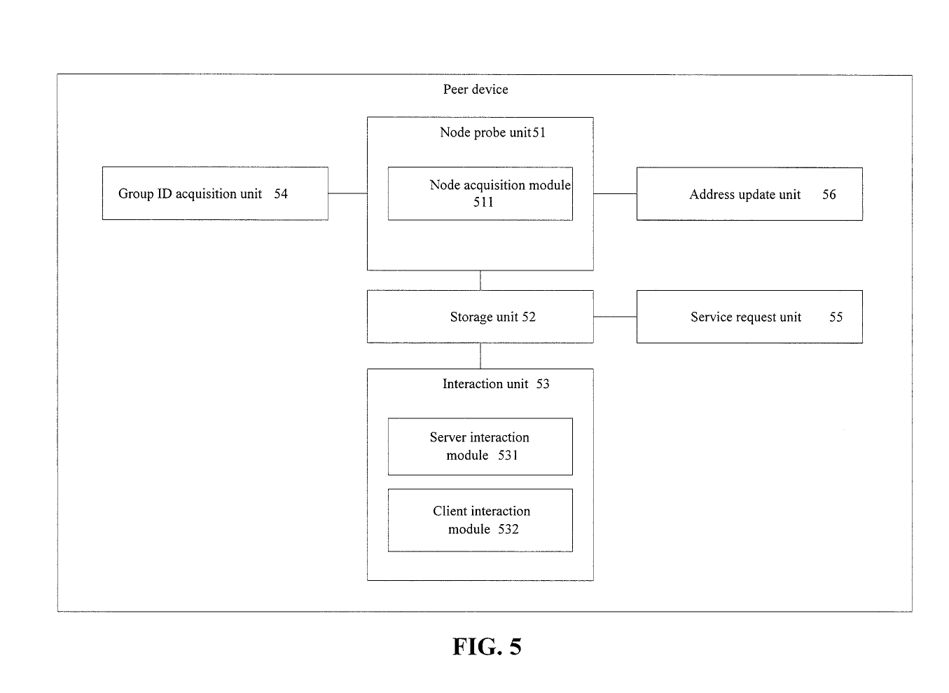

This embodiment provides a peer device that may be used as the client in embodiment 1 or the server in embodiment 2. As shown in FIG. 5, the peer device includes a node probe unit 51, a storage unit 52 and an interaction unit 53.

The node probe unit 51 is used to acquire the address information of at least one SN from the BSSN, wherein both the BSSN and the SN belong to the overlay network. The storage unit 52 is used to store the address information. The interaction unit 53 is used to report to the SN corresponding to one of the address information the server information and to acquire the server information from the SN corresponding to one of the address information, respectively. The storage unit 52 is also used to store the server information.

In this embodiment, the device may further include a group ID acquisition unit 54, a service request unit 55 and an address updating unit 56.

The group ID acquisition unit 54 acquires the group ID according to the rule of service type grouping protocol. The service request unit 55 sends service requesting message to a server corresponding to one of server information based on the server information in a polling or random way. The address updating unit 56 periodically sends the node requesting message carrying the acquired group ID to the SN corresponding to one of the address information, and updates the saved address information with the returned address information after receiving the address information carried by a returned node response message.

The node probe unit 51 includes a node probe module 511, which is used to send a node requesting message carrying the group ID to the BSSN after the group ID acquisition unit 54 has acquired the group ID, and acquire the address information of the SN having the same group ID in the overlay network from the node response message returned by the BSSN.

The interaction unit 53 includes a server interaction module 531 and a client interaction module 532.

The server interaction module 531 is used to periodically report the server information to the SN corresponding to one of the address information by a heartbeat message carrying the group ID, wherein the one address information is selected in a random or polling way; and/or

The client interaction module 532 periodically sends the requesting message for acquiring the server information to the SN, wherein the requesting message carries the service type to be requested and the group ID, and acquires the server information from the SN. The SN responses the server information, wherein the SN is selected in a random or polling way.

The device provided by this embodiment may facilitate to use at least one SN in the overlay network as an agent, and acquire the server information by said at least one SN, thus make SNs in the overlay network have same functions. Accordingly, no single point is formed and the system has high availability. Furthermore, impact on the entire system during the expansion is very tiny and thus a smooth expansion is realized.

### Embodiment 3

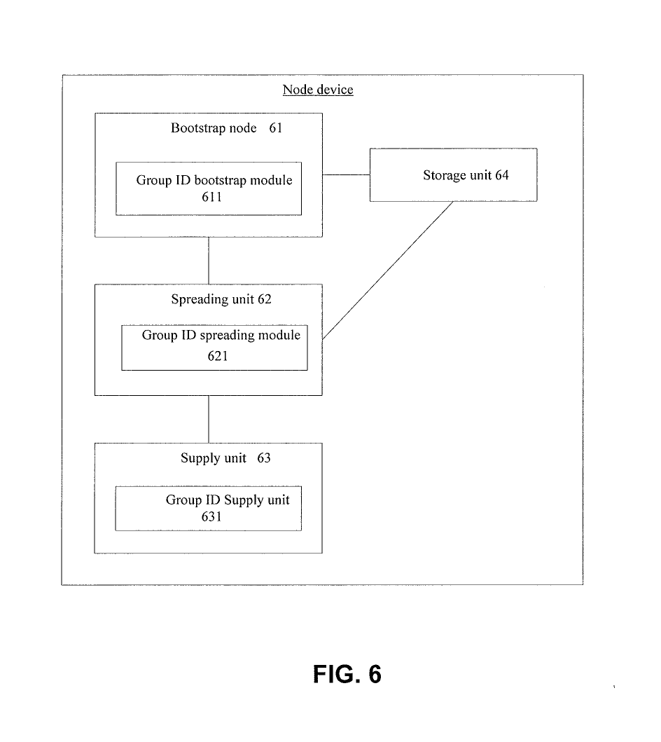

This embodiment provides a node device that belongs to the overlay network and is allocated with a group ID, said node device may also be used as the BSSN or the SN in the embodiment 1. As shown in FIG. 6, said node device includes a bootstrap unit 61, a spreading unit 62 and a supply unit 63.

The peer sends a request message to SN to acquire at least one available SN. The bootstrap unit 61 receives the request message from the peer, and sends the address information of the SNs capable of serving the peer back to said peer, wherein said peer includes a server and a client. The spreading unit 62 receives the server information from the server, saves and spreads said server information to the other node device. The supply unit 63 receives the server information request from the client and sends the stored server information back to said client.

In this embodiment, the device further includes a storage unit 64.

The storage unit 64 stores the node information of other node devices. Said node information is updated as interactions occur between node devices.

The bootstrap unit 61 includes a group ID bootstrap module 611. When the peer sends a request message to acquire at least one SN that has the same group ID of the peer, the group ID bootstrap module 611, based on the group ID sent by the peer and the group IDs of the SN information stored in the storage unit, sends the address information of the SNs in the overlay network having the same group ID as the peer.

The spreading unit 62 includes a group ID spread module 621. Said group ID spread module 621 is used to receive a heartbeat message carrying the group ID and the server information from the server, and spread said server information to other node devices in the overlay network having the same group ID as that of the node information stored in the storage unit 64.

The supply unit 63 includes a group ID supply unit 631. The group ID supply unit 631 is used to receive from a client a requesting message for acquiring the server information that carries the requested service type and the group ID, acquire corresponding server information based on the requested service type and the group ID, and send the corresponding server information to said client by a response message for acquiring server information.

The device provided by this embodiment may interact with the peer dynamically, acts as an agent between the client and the server to provide the available address information or server information. By this way, there is no single point in system, and the system is expanded smoothly. And load balance is realized.

### Embodiment 4

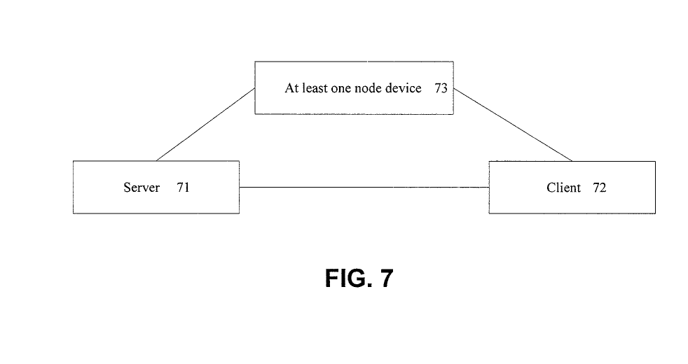

This embodiment provides a system for load balancing. As shown in FIG. 7, the system includes a server 71, a client 72 and at least one node device 73.

The Server 71 is used to acquire the address information of at least one node device 73 from node devices, save said address information, and report its server information to the node device 73 corresponding to one of the address information.

The Client 72 is used to acquire the address information of at least one node device from the node device 73, save said address information, acquire the server information from the node device corresponding to one of the address information, and save said acquired server information.

At least one node device 73 is used to receive the request of acquiring at least one node device from the server 71 and client 72, and send the address information of node device capable of serving said server 71 and client 72 back to said server 71 and client 72; receive and save the server information from the server 71, spread said server information to other node devices; and receive server information request from the client 72 and send the saved server information to said client 72.

At least one node device 73 belongs to the overlay network.

Besides, the server 71 and client 72 follows the service type grouping protocol that specifies the group ID based on the service type. Said group ID is the one of a group within which the SN is available for the service type in the overlay network. Alternatively, if the available group ID is specified by said protocol according to the domain, the group ID is that of a group to which the SN available for the domain in the overlay network belongs.

In this embodiment, the at least one node device is grouped and each group is assigned with a group ID in the overlay network.

The system provided in this embodiment of the invention is of the following effects: a new method of utilizing the overlay network is provided, wherein at least one SN in the overlay network is used as an agent, which is used by the client to acquire server information so as to know which server is available. Accordingly, the server can report the server information to one SN, and spread by the one SN the server information to other SNs. By this way, the functions of all SNs in the overlay network are same. Therefore, no single point is formed, and impacts on the entire system during the expansion are small and thus a smooth expansion is realized. Furthermore, no additional complicated mechanism is introduced to reduce the load of a single point or secure the service performance of the single point. That is, the complexity of the system is reduced and thus the system is used with greater facility and is of high availability.

It shall be noted that if a web explorer is modified to be a peer accessing the overlay network to acquire the server information dynamically, it means that the solutions provided by the embodiments of the invention is applied and thus falls within the scope of the invention without departing the spirit of the invention.

Based on the description of above embodiments, it is obvious to the skilled in the art that the invention can be implemented by using software and a general hardware or only a hardware. However, the former is preferred under most circumstances. In other words, the technical solution of the invention or the parts improved with respect to the prior art can be implemented in the form of software product. The soft ware product, including instructions enable a device (it may be a lap top computer and etc.) implement the methods mentioned in the embodiments of the invention, may be stored in a readable medium such as a floppy disk, a hard disk or an optical disk of the computer.

The above descriptions are only the specific implementation embodiments of the invention, and are not used to limit the scope for the invention. A change or a substitution made by a skilled in the art can make based on the technical scope disclosed by the invention follows within the protection scope for the invention. Therefore, the scope for the present invention is claimed by the following claims.

What is claimed is:

1. A method of load balancing, including:
acquiring by a peer address information of at least one super node (SN) from a bootstrap super node (BSSN), wherein both said BSSN and said at least one SN belong to an overlay network;
if the peer is a server, saving by the server said address information and reporting by the server server information to a respective SN corresponding to one of the address information, and spreading by the SN said server information to other SNs; and
if the peer is a client, saving by the client said address information and acquiring by the client the server information from a respective SN corresponding to one of the address information and saving the server information at the client.

2. The method of claim 1, before acquiring by the peer the address information of at least one SN from a BSSN, further including:
following by the peer a service type grouping protocol, wherein said protocol specifies a group ID according to a service type, and the group ID is that of a group in which a SN in the overlay network is available to the service type; or
following by the peer the service type grouping protocol, wherein said protocol specifies an available group ID according to a domain, and the group ID is that of a group in which a SN in the overlay network is available to the domain;
wherein, SNs in the overlay network are grouped and each group is assigned with a group ID.

3. The method of claim 2, wherein each SN of the overlay network stores node information of other SNs, said node information is updated timely through interactions between SNs, after following by the peer the service type grouping protocol, the method further includes:
acquiring by the peer a group ID based on one or more rules of the service type grouping protocol, and periodically sending by the peer a node requesting message carrying the acquired group ID to a SN corresponding to the one of the address information;
sending by the SN receiving the node requesting message, based on its own address information and group ID in the SN's associated node information, a node response message carrying address information of a SN having the same group ID as the acquired group ID in the node requesting message to the peer; and
updating by the peer previously saved address information according to the carried address information in the node response message.

4. The method of claim 2, after following by the peer the service type grouping protocol, further including:
if said peer is a server, acquiring by the server the group ID according to one or more rules of the service type grouping protocol and the service type the server can provide; or, acquiring by the server the group ID according to one or more rules of the service type grouping protocol and the domain to which said server belongs;
acquiring by the server the address information of at least one super node from a BSSN further including:
sending by the server a node requesting message carrying said acquired group ID to the BSSN;
sending by the BSSN a node response message to the server, the message carrying the address information of the super node in the overlay network having the same group ID as that of the group ID provided by the server.

5. The method of claim 4, wherein reporting by the server the server information to a SN corresponding to the one of the address information, and spreading by the SN receiving said server information to other SNs further includes:
reporting periodically by the server its server information to a respective SN corresponding to one of the address information using a heartbeat message carrying the group ID, and said one of the address information is selected in a random or polling way;
spreading by the SN receiving said server information the server information to other SNs having the same group ID in the overlay network; and
storing by the other SNs having the same group ID said server information.

6. The method of claim 2, after following by the peer the service type grouping protocol, the method further including: if said peer is a client, acquiring by the client the group ID, based on one or more rules of the service type grouping protocol and the service type to be requested; or, acquiring by the client the group ID, based on one or more rules of the service type grouping protocol and the domain to which said client belongs;
acquiring by the client the address information of at least one SN from a BSSN further including:
sending by the client a node requesting message carrying said acquired group ID to the BSSN;
sending by the BSSN a node response message to the client, the message carrying the address information of the SN having the same group ID as that of the group ID provided by the client.

7. The method of claim 6, acquiring by the client the server information from a SN corresponding to one of the address information including:
sending periodically by the client a requesting message for acquiring the server information to a respective SN corresponding to one of the address information, wherein said requesting message carries the service type and the group ID, and said SN is selected in a random or polling way;
acquiring by the SN receiving the requesting message the server information based on the requested service type, and sending the server information to the client using a response message.

8. The method of claim 1, after saving by the client said server information, further including:
sending in a random or polling way a request to a corresponding server, based on said server information, when said client request requests service from the server;
wherein the server information includes a service type the server can provide, an IP address and a port number of the server, and a load status of the server.

9. A peer device, characterized in that, including:
a node probe unit for acquiring address information of at least one SN from a BSSN, wherein both the BSSN and the SN belong to an overlay network;
a storage unit for storing the address information; and
an interaction unit for reporting server information to a SN corresponding to one of the address information or acquiring the server information from the SN corresponding to the one of the address information;
wherein the storage unit is also used for storing the server information.

10. The device of claim 9, characterized in that, further including:
a group ID acquisition unit for acquiring a group ID according to one or more rules of a service type grouping protocol; and
the node probe unit further including:
a node probe module for sending a node requesting message including a group ID acquired by the group ID acquisition unit to the BSSN, and acquiring from the BSSN the address information of the SN having the same group ID in the overlay network using the node response message.

11. The device of claim 10, characterized in that the interaction unit including:
a server interaction module for reporting periodically the server information to a respective SN corresponding to one of the address information using a heartbeat message carrying the group ID, and said one of the address information is selected in a random or polling way; and/or
a client interaction module for sending periodically a requesting message for acquiring the server information to a respective SN corresponding to one of the address information, wherein said requesting message carries the service type to be requested and the group ID, and said one of the address information is selected in a random or polling way.

12. The device of claim 10, characterized in that said device further including:
a service requesting unit for sending a service requesting message to a corresponding server according to the server information in a random or polling way.

13. A node device, characterized in that the node device belongs to an overlay network, the device including:
a bootstrap unit for receiving from a peer a request of acquiring at least one SN, and sending address information of a SN capable of serving the peer back to said peer, wherein the peer includes a server and a client;
a spread unit for receiving and storing server information from the server, and spreading the server information to other node devices;
a supply unit for receiving a request for server information from the client and sending the stored server information to the client.

14. The device of claim 13, characterized in that the node device is provided with a group ID, said device further including:
a storage unit for storing node information of other node devices, and said node information is updated timely through interactions between respective node devices;
the bootstrap unit including:
a group ID bootstrap module for sending the address information of a node device to the peer, the node device having the same group ID in the overlay network according to a group ID sent from the peer and a group ID of node information stored in the storage unit, in response to a request sent by the peer of acquiring at least one node carrying the group ID of the peer.

15. The device of claim 14, characterized in that the spread unit further including:
a group ID spread module for receiving a heartbeat message carrying the group ID and the server information from the server, and spreading the server information to other node devices having the same group ID in the overlay network according to the group ID of the node information stored in the storage unit.

16. The device of claim 14, characterized in that the supply unit including:
a group ID supply unit for receiving from the client a requesting message for acquiring the server information, wherein the requesting message carries the requested service type and the group ID, acquiring server information according to the requested service type and the group ID, and sending said corresponding server information to the client using a response message of acquiring the server information.

17. A system of load balancing, characterized in that including:
a server for acquiring address information of at least one node device from a node device, saving the address information, and reporting its server information to a node device corresponding to one of the address information;
a client for acquiring the address information of the at least one node device from a node device, saving the address information, acquiring the server information from the node device corresponding to the one of the address information, and saving the acquired server information; and
at least one node device for receiving a request of acquiring at least one node device from the server and the client, and sending address information of a node device capable of serving the server and the client to the server and the client; receiving and saving the server information from the server, spreading the server information to other node devices; and
receiving a request for the server information from the client and returning the saved server information to said client;
wherein, the at least one node device belongs to an overlay network.

18. The system of claim 17, characterized in that the server and the client follow a service type grouping protocol, wherein said service type grouping protocol specifies a group ID according to a service type, and the group ID is that of a group in which a SN is available to the service type in the overlay network; or said service type grouping protocol specifies an available group ID according to a domain, and the group ID is that of a group in which a SN is available to the domain in the overlay network;
wherein, at least one node device has been grouped in the overlay network and each group has been assigned with a group ID in the overlay network.
